(19) United States
(12) Patent Application Publication
(10) Pub. No.: US 2007/0155432 A1
(43) Pub. Date: Jul. 5, 2007

(54) Apparatus for improved reception sensitivity of base transceiver station

(76) Inventor: Kyoung Dok Yun, Seoul (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/560,512

(22) PCT Filed: Jul. 23, 2004
(86) PCT No.: PCT/KR04/01852

§ 371 Date: Nov. 6, 2006

(30) Foreign Application Priority Data
Jul. 24, 2003 (KR) 10-2003-0051152

(51) Int. Cl. H04B 1/38; H04M 1/00

(52) U.S. Cl. 455/561

(57) ABSTRACT

In a transmission/reception apparatus in a base transceiver station (BTS), a commercial surface acoustic wave filter (SAW filter) can be used for suppressing transmission signals interfering with the reception path. By suppressing the interference signals, the reception sensitivity can be improved. In one embodiment of the present invention, an apparatus for processing trans-mission/reception signals in a BTS, comprises: a coupler connected to an antenna for providing reception signals; a duplexer having three terminals for routing the reception signals at a first terminal to a second terminal of the duplexer, and routing transmission signals at a third terminal of the duplexer to the first terminal, the coupler being further operative to provide the transmission signals at the first terminal to the antenna; and a narrow band low-noise amplifier connected to the second terminal for amplifying the reception signals from the second terminal, the narrow band low-noise amplifier being operative to suppress out-of-band interference signals such that reception sensitivity can be improved.

### TECHNICAL FIELD

The present invention generally relates to an apparatus for improving the reception sensitivity of a base transceiver station (BTS) in a code division multiple access (CDMA) mobile communication system. More particularly, the present invention relates to removing transmission signals of adjacent Frequency Assignments (FAs) included in reception signals, which interfere with the reception path, by using a commercially available surface acoustic wave (SAW) filter to thereby improve the reception sensitivity and allow the addition of FAs to a low-price BTS.

### BACKGROUND ART

In a typical CDMA mobile communication system, the gap between a transmission frequency band and a reception frequency band tends to decrease since newly assigned frequency does not overlap with existing frequency bands. Therefore, there has been a tendency to reinforce the attenuation characteristics of a duplexer so as not to interfere with the existing services.

Specifically, in a low cost BTS, a low cost High Power Amplifier (HPA) and a Linear Power Amplifier (LPA) with low output power are used instead of a LPA with high output power. In such case, the HPA is used for the main path to amplify only one FA, where a duplex-type front-end unit (FEU) receives/transmits signal while an FEU for the diversity path operates only for reception of signals.

FIG. 1 illustrates a structural block diagram of a transmission/reception apparatus of a base transceiver station in a conventional CDMA mobile communication system. As shown in FIG. 1, the transmission/reception apparatus comprises an analog conversion board assembly (ACA) 11, an LPA 12, an antenna 14, a first FEU 13, an antenna 15, and a second FEU 16. The LPA 12 amplifies the power of transmission signals from the ACA 11. The first FEU 13 processes the transmission signals from the LPA 12 and broadcasts the signals through the antenna 14. The first FEU 13 also processes main path reception signals received from the antenna 14 and delivers the signals to the ACA 11. The antenna 15 receives the signals on the diversity path. The second FEU 16 processes reception signals received through the antenna 15 and delivers the signals to the ACA 11.

As explained above, the transmission/reception apparatus of a conventional CDMA mobile communication system generates transmission signals on the main path. Therefore, only one amplifier is used. This applies not only when one frequency assignment (FA) is used but also when another FA is later added. In such case, high output power is required for the amplifier in order to maintain linearity after the addition of FA. For example, if the system requires 20 W/FA as the output power in order to support using 3 FAs, the LPA with 60 W output power should be integrated. Obviously, this increases costs.

The conventional solution for addressing such type of problem was to assign 1FA for the main path and 2FAs for the diversity path. FIG. 2 illustrates a structural block diagram of such modified transmission/reception apparatus of a base transceiver station in a conventional CDMA motile communication system. As shown in FIG. 2, the transmission/reception apparatus comprises an ACA 21, a HPA 22, a first FEU 23, an antenna 24, a LPA 25, a second FEU 27 and an antenna 26. The HPA 22 amplifies the power of main path transmission signals from the ACA 21. The first FEU 23 processes the main path transmission signals from the HPA 22 and broadcasts the signals through the antenna 24. The first FEU 23 also processes 1FA reception signals received on the main path at the antenna 24 and delivers the signals to the ACA 21. The LPA 25 amplifies the power of the diversity path transmission signals from the ACA 21. The second FEU 27 processes the diversity path transmission signals from the LPA 25 and broadcasts the signals through the antenna 26. The second FEU 27 also processes the 2FA reception signals received on the diversity path at the antenna 26 and delivers the signals to the ACA 21.

As explained above, the transmission/reception apparatus of the conventional CDMA mobile communication system uses a 20 W HPA for the main path. In case of FA addition, a 40 W LPA is used for the diversity path.

FIG. 3 illustrates the structural block diagram of an exemplary FEU shown in FIGS. 1 and 2. In FIG. 3, references numeral 33 refers to an FEU. Reference numeral 31 refers to a duplexer for switching between transmission and reception signals. Reference numeral 32 refers to a coupler. Reference numeral 33 refers to a Low Noise Amplifier (LNA) for amplifying reception signals.

As noted above, the BTS configuration has difficulty in adding FAs when the gap between the transmission and reception frequencies is no more than 10 MHz. Also, because the isolation of the duplexer is generally insufficient, the reception sensitivity becomes degraded when the transmission signals of an adjacent FA interfere with reception signals.

### DISCLOSURE OF INVENTION

### Technical Problem

It is, therefore, an objective of the present invention to provide an apparatus for suppressing transmission signals of an adjacent FA, which operates as interference signals to the reception path, thereby increasing reception sensitivity.

The present invention uses a commercial surface acoustic wave (SAW) filter for suppressing the transmission signals. By the attenuation of the SAW filter, the interference of transmission signals in adjacent FA, which occurs due to insufficient isolation of a duplexer, can be prevented.

### Technical Solution

In one embodiment of the present invention, an apparatus for processing transmission/reception signals in a base transceiver station (BTS), comprises: a coupler connected to an antenna for providing reception signals; a duplexer having three terminals, a first terminal of the duplexer connected to the coupler for routing the reception signals at the first terminal to a second terminal of the duplexer, and further routing transmission signals at a third terminal of the duplexer to the first terminal, said coupler being further operative to provide the transmission signals at the first terminal to the antenna; and a narrow band low-noise amplifier connected to the second terminal for amplifying the reception signals from the second terminal, said narrow band low-noise amplifier being operative to suppress out-of-band interference signals such that reception sensitivity can be improved.

In another embodiment of the present invention, an apparatus for processing transmission/reception signals in a base transceiver station (BTS), comprises: a coupler connected to an antenna for providing reception signals; a duplexer having three terminals, a first terminal of the duplexer connected to the coupler for routing the reception signals at the first terminal to a second terminal of the duplexer, and further routing transmission signals at a third terminal of the duplexer to the first terminal, said coupler being further operative to provide the transmission signals at the first terminal to the antenna; a low-noise amplifier for amplifying the reception signals from the second terminal; and a surface acoustic wave (SAW) filter for suppressing the out-of-band interference signals such that reception sensitivity can be improved.

Yet in another embodiment of the present invention, a transceiver in a BTS comprises an Analog Conversion board Assembly (ACA), an amplifier for amplifying transmission signal, and a front-end unit for processing transmission and reception signals. The transceiver is characterized in that a SAW filter module is inserted between the front-end unit and the ACA for suppressing out-of-band interference signals included in the reception signals.

The foregoing and other objects and features of the present invention will become more fully apparent from the following description, appended claims and their accompanying drawings.

### BRIEF DESCRIPTION OF THE DRAWINGS

These drawings depict only the preferred embodiments of the present invention and should not be considered as limitations of its scope. These as well as other features of the present invention will become more apparent upon reference to the drawings in which:

FIG. 1 illustrates a structural bock diagram of a transmission/reception apparatus of a base transceiver station in a conventional CDMA mobile communication system.

FIG. 2 illustrates a structural bock diagram of another transmission/reception apparatus of a base transceiver station in a conventional CDMA mobile communication system.

FIG. 3 illustrates a structural block diagram of a FEU shown in FIG. 1.

FIG. 4 illustrates the gaps between transmission and reception signals, and between transmission and reception frequency bands in the conventional system.

FIG. 5 illustrates a structural block diagram of an apparatus, which is in accordance with a first embodiment, for improving reception sensitivity of a base transceiver station according to the present invention.

FIG. 6 illustrates a structural bock diagram of an apparatus, which is in accordance with a second embodiment, for improving reception sensitivity of a base transceiver station according to the present invention.

FIG. 7 illustrates a structural block diagram of an apparatus, which is in accordance with a third embodiment, for improving reception sensitivity of a base transceiver station according to the present invention.

FIG. 8 illustrates a structural bock diagram of a transmission/reception apparatus of a base transceiver station in a CDMA mobile communication system utilizing the third embodiment of the present invention.

FIG. 9 illustrates waveforms of signals received at RX OUT terminal when FA1 and FA3 signals are used on the diversity path in order to show the effect of using a SAW filter.

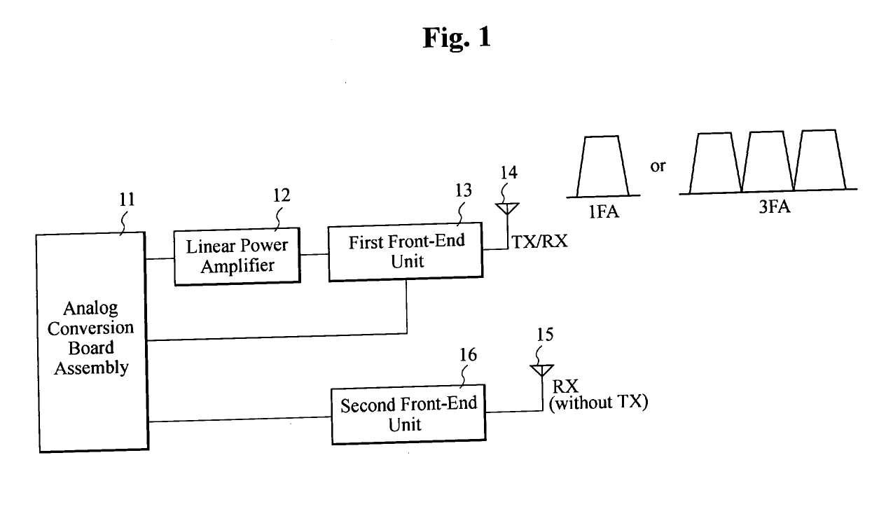

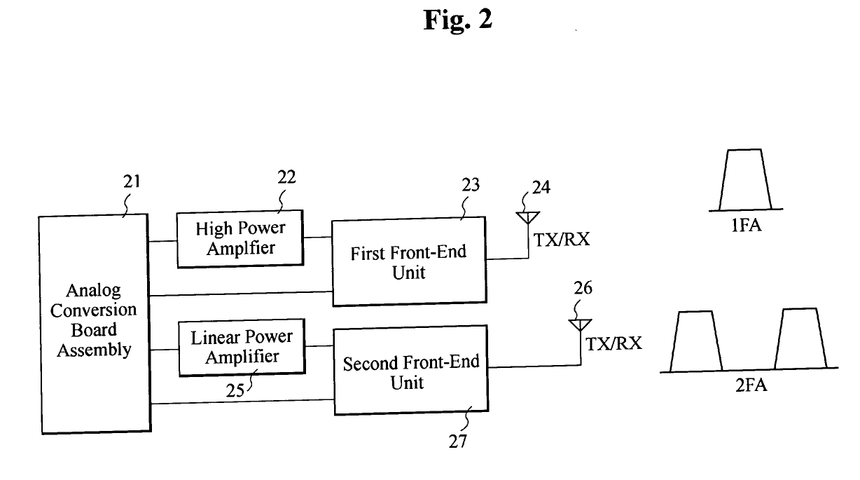

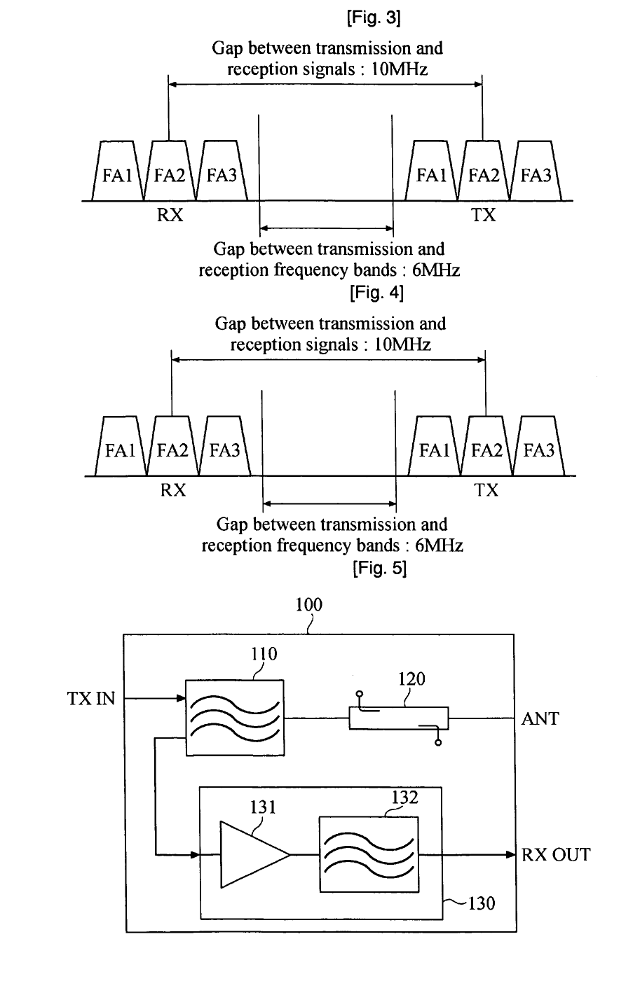

### BEST MODE FOR CARRYING OUT THE INVENTION

The preferred embodiments of the present invention are explained below with reference to the figures.

When a new service is introduced, frequencies that have not yet been assigned to existing services are assigned to the new service. This is so that the existing service band is not affected. Therefore, as new frequencies are assigned to new services that do not overlap with frequencies which were already assigned, the gap between the transmission and reception bands is narrowed. In this regard, the conventional method, which relies solely on the isolation characteristics of a duplexer in attenuating transmission signals that interfere with reception, fails to perform in a desirable and efficient manner. Simply put, it does not work well.

When only the main path is used for transmission, the transmission signals do not affect reception sensitivity since they do not exist on the diversity path and thus barely interfere with the receiving path. For expanded configuration wherein an LPA is used for diversity path transmission, however, transmission signals in adjacent FAs will interfere with the received signals, thereby decreasing receiver sensitivity. For such expanded configuration, when signals are transmitted both on the main and diversity paths, transmission signals in adjacent FAs will interfere with received signals, thereby degrading receiver performance.

In order to address and resolve such problems, the present invention utilizes a SAW filter that is commercially available in the present market.

### Embodiment 1

FIG. 5 illustrates a structural bock diagram of an apparatus, which is in accordance with a first embodiment, for improving reception sensitivity of a base transceiver station according to the present invention. Compared to the conventional transmission/reception apparatus in a BTS, which comprises an ACA, an amplifier for amplifying transmission signals, an FEU for properly processing transmission/reception signals, the first embodiment modifies the configuration of the FEU 100.

As shown in FIG. 5, the FEU 100 comprises a duplexer 110 for routing transmission and reception signals, a coupler 120 for coupling transmission signals from the duplexer 110 and reception signals received at an antenna, and a narrow-band low-noise amplifying portion 130 having a low-noise amplifier 131 and a SAW filter 132.

The first embodiment of the present invention, which is explained above, operates as follows. The duplexer 110 of the FEU 100 delivers the transmission signal (TX IN) from the ACA to the coupler 120. The duplexer 110 also delivers the reception signals, which are delivered through the coupler 120 to the low-noise amplifier 131 of the narrow-band low-noise amplifying portion 130. The low-noise amplifier 131 amplifies the reception signals outputted from the duplexer 110 with low noise. The SAW filter 132 receives the reception signals from the low-noise amplifier and suppresses out-of-band interference signals included in the reception signals. This improves reception sensitivity. The out-of-band interference signals are placed outside of the frequency bands designated for reception signals and thus may be eliminated from the reception signals by the SAW filter 132.

### Embodiment 2

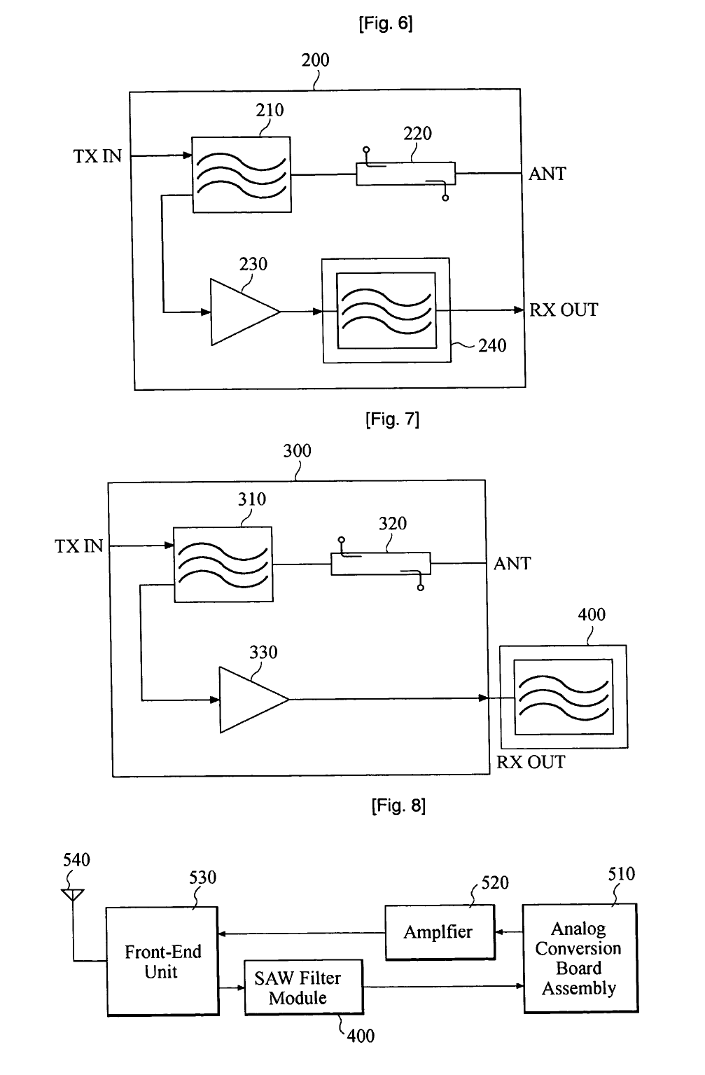

FIG. 6 illustrates a structural block diagram of an apparatus, which is in accordance with a second embodiment, for improving reception sensitivity of a base transceiver station according to the present invention. Compared to the conventional transmitting/receiving apparatus in a BTS, which comprises an ACA, an amplifier for amplifying transmission signal, a FEU for appropriately processing transmitted/received signals, the second embodiment modifies the configuration of the FEU 200.

As shown in FIG. 6 the FEU 200 comprises a duplexer 210 for routing transmission and reception signals, a coupler 220 for coupling transmission signals from the duplexer 210 and receptions signals received through an antenna, a narrow-bandwidth amplifier 230, and a SWA filter module 240

The second embodiment of the present invention, which is explained above, operates as follows. The duplexer 210 delivers the transmission signal to the coupler 220. The duplexer 210 also delivers the reception signals, which are delivered through the coupler 220 to the low-noise amplifier 230. The low-noise amplifier 230 amplifies the reception signals outputted from the duplexer 210 with low noise. The SAW filter module 240 receives the reception signals from the low-noise amplifier 230 and suppresses out-of-band interference signals included in the reception signals. As such, the receiver sensitivity becomes improved.

### Embodiment 3

FIG. 7 illustrates a structural block diagram of an apparatus, which is in accordance with a third embodiment, for improving reception sensitivity of a base transceiver station according to the present invention. In this embodiment, a SWA filter module 400 is inserted between an ACA and a FEU. The SAW filter module 400 suppresses out-of-band interference signals included in the receptions signals outputted from the FEU 300 thereby improving reception sensitivity.

FIG. 8 illustrates the application of the structure (shown in FIG. 7) to a transmission/reception apparatus in a BTS. In FIG. 8, reference numeral 510 refers to an ACA, reference numeral 520 refers to an amplifier for amplifying transmission signals, reference numeral 530 refers to an FEU for appropriately processing transmission/reception signals, and reference numeral 540 refers to an antenna.

Preferably, the commercial SAW filter used in Embodiments 1, 2, and 3, as explained above, has a low insertion loss of 1-2 dB and an attenuation characteristic of about 50 dB so s to suppress out-of-band interference signals. By using such SAW filter to reinforce the attenuation characteristic, the signals in the transmission band, which are amplified by a LPA, are eliminated and prevented from effecting the reception path. This increases reception sensitivity.

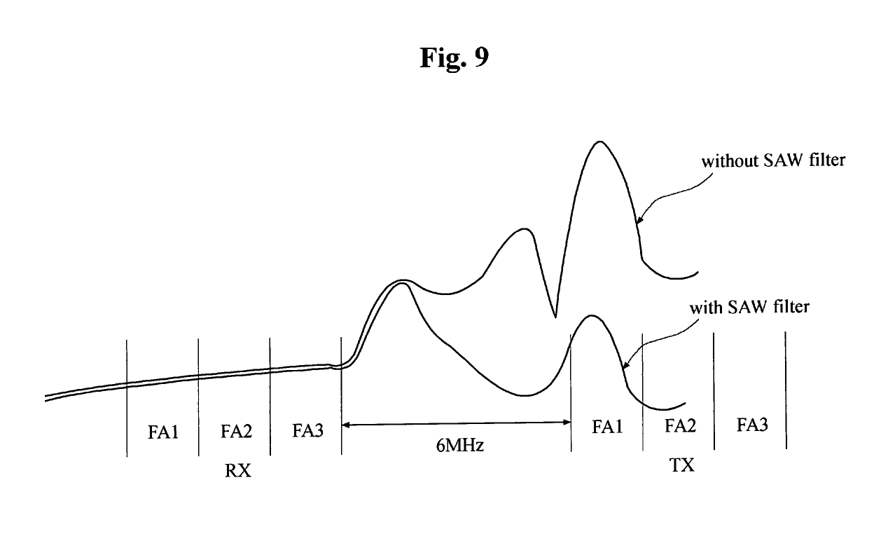

The actual test, which is shown in FIG. 9, illustrates that the interference signals are suppressed by approximately 50 dB. When the isolation by a duplexer is not sufficient, which causes transmission signals in the adjacent FAs to be inputted to the ACA, such suppression eliminates interference signals from a receiving path. This improves the sensitivity of a BTS.

In the proposed system, the worst situation is when FA is added and the transmission signals in FA1 interfere with the reception signals in FA3. In this case, the gap between the transmission and reception signals is shortest, as shown in FIGS. 4 and 9. In order to test such situation, FA1 and FA3 are assigned for diversity path. Then, the reception sensitivity test is performed using the FA3 reception signals with FA1 transmission signals interfering with the reception path. As shown in FIG. 9, the test shows that the addition of SAW filter suppresses the interference signals, thereby preventing degradation of receiver sensitivity by about 10-15 dB.

### INDUSTRIAL APPLICABILITY

In accordance with the present invention, the reception sensitivity can be improved by using a commercial SAW filter for eliminating transmission signals in adjacent FAs, which operate as interference signals on the reception path. Therefore, even when the gap between transmission and reception bands is short, FA addition becomes available.

1. An apparatus for processing transmission/reception signals in a base transceiver station (BTS), comprising:
a coupler connected to an antenna for providing reception signals;
a duplexer having three terminals for routing the reception signals at a first terminal to a second terminal of the duplexer, and routing transmission signals at a third terminal of the duplexer to the first terminal, said coupler being further operative to provide the transmission signals at the first terminal to the antenna; and
a narrow band low-noise amplifying portion connected to the second terminal for amplifying the reception signals from the second terminal, said narrow band low-noise amplifier being operative to suppress out-of-band interference signals such that reception sensitivity is improved.

2. An apparatus for processing transmission/reception signals in a base transceiver station (BTS), comprising:
a coupler connected to an antenna for providing reception signals;
a duplexer having three terminals for routing the reception signals at a first terminal to a second terminal of the duplexer, and routing transmission signals at a third terminal of the duplexer to the first terminal, said coupler being further operative to provide the transmission signals at the first terminal to the antenna;
a low-noise amplifier connected to the second terminal for amplifying the reception signals from the second terminal; and
a surface acoustic wave filter (SAW filter) for suppressing out-of-band interference signals such that reception sensitivity can be improved.

3. A transceiver in a BTS, comprising an Analog Conversion board Assembly (ACA), an amplifier for amplifying transmission signals, and a front-end unit for processing transmission and reception signals, wherein the transceiver is characterized in that a SAW filter module is inserted between the front-end unit and the ACA for suppressing out-of-band interference signals included in the reception signals.
